(19) United States
(12) Patent Application Publication
(10) Pub. No.: US 2026/0364947 A1
(43) Pub. Date: Nov. 19, 2026

(54) INK REPLENISHMENT CONTAINER

(71) Applicant: SEIKO EPSON CORPORATION, Tokyo (JP)

(72) Inventors: Tadashi WATANABE, Matsumoto-shi (JP); Tadahiro MIZUTANI, Shiojiri-shi (JP); Atsushi KOBAYASHI, Matsumoto-shi (JP); Shun OYA, Kiso-machi (JP); Yuta KOIKE, Matsumoto-shi (JP)

(73) Assignee: SEIKO EPSON CORPORATION, Tokyo (JP)

(21) Appl. No.: 19/675,601

(22) Filed: May 13, 2026

(30) Foreign Application Priority Data
May 14, 2025 (JP) 2025-081050

(51) Int. Cl. B41J 2/175

(52) U.S. Cl. CPC B41J 2/17596; B41J 2/17509; B41J 2/17513; B41J 2/17523; B41J 2/1754

(57) ABSTRACT

An ink replenishment container includes: a container portion having an ink accommodating portion and a spout portion connected to the container portion and having an outlet, wherein the spout portion includes a spring valve unit, the spring valve unit including a valve body, a seal member located between the valve body and the outlet, and a spring member that biases the valve body toward the seal member to bring the valve body into contact with the seal member in a valve-closed state of the spring valve unit, at least one of the container portion and the spout portion has a metal portion containing metal, and the spring member has a spring force that is smaller than a self-weight of the ink replenishment container including the container portion in a state where the ink is empty and the spout portion.

The present application is based on, and claims priority from JP Application Serial Number 2025-081050, filed May 14, 2025, the disclosure of which is hereby incorporated by reference herein in its entirety.

### BACKGROUND

### 1. Technical Field

The present disclosure relates to an ink replenishment container.

### 2. Related Art

JP-A-2023-43905 discloses an ink replenishment container which is connected to an ink inlet flow path member in an inverted orientation to replenish ink to a printer. The ink replenishment container is provided with an outlet valve unit having a valve body and a spring member in an ink outlet. In the ink replenishment container before being mounted on the printer, the spring member biases the valve body in a direction in which the valve body is closed. When the ink replenishment container is mounted on the printer, the ink inlet flow path member connected to the ink replenishment container pushes the valve body against the biasing force of the spring member, whereby the valve body is opened and the ink is replenished. During the ink replenishment, a seal member disposed at the ink outlet of the ink replenishment container comes into contact with the outer circumferential surface of the ink inlet flow path member to seal the ink inlet flow path member so that the ink does not leak to the outside.

However, in a case where the biasing force of the spring member that biases the valve body such that the valve is closed is large, there is a possibility that the ink replenishment container moves in a direction away from the ink introduction member of the printer during the ink replenishment due to the biasing force of the spring member. As a result, instability of an ink replenishment orientation such as inclination of the ink replenishment container or detachment of the ink replenishment container from the ink introduction member is caused, and there is a possibility that leakage of ink to a portion other than the ink introduction member, a decrease in ink replenishment amount, an increase in ink replenishment time, or the like occurs, and there is room for improvement in convenience for a user.

### SUMMARY

According to a first aspect of the present disclosure, there is provided an ink replenishment container from which ink is replenished to a printer, in which an ink introduction member communicating with an ink tank extends vertically upward, via the ink introduction member. The ink replenishment container includes: a container portion having an ink accommodating portion capable of accommodating the ink; and a spout portion connected to the container portion and having an outlet through which the ink is discharged, wherein the spout portion includes a spring valve unit, the spring valve unit including a valve body, a seal member located between the valve body and the outlet and constituting a valve seat, and a spring member that biases the valve body toward the seal member to bring the valve body into contact with the seal member in a valve-closed state of the spring valve unit, at least one of the

container portion and the spout portion has a metal portion containing metal, and the spring member has a spring force that is smaller than a self-weight of the ink replenishment container including the container portion in a state where the ink is empty and the spout portion.

### BRIEF DESCRIPTION OF THE DRAWINGS

FIG. 1 is a perspective view of a printer.

FIG. 2 is a perspective view of an ink tank.

FIG. 3 is a perspective view showing a state where ink is replenished to an ink tank by using an ink replenishment container.

FIG. 4 is a top view of an ink tank accommodating unit in a state where sealing cap members are removed.

FIG. 5 is an exploded perspective view of the ink replenishment container.

FIG. 6 is a first perspective view of a spring valve unit.

FIG. 7 is a second perspective view of the spring valve unit.

FIG. 8 is a view showing a configuration of a valve body.

FIG. 9 is a side view of the ink replenishment container in an upright state.

FIG. 10 is a partial sectional view of the ink replenishment container and the ink tank in a replenishment state.

FIG. 11 is a partial sectional view of the ink replenishment container in a non-replenishment state.

FIG. 12 is a partial sectional view of the ink replenishment container and the ink tank of a fourth embodiment in the replenishment state.

FIG. 13 is a partial sectional view of the ink replenishment container of the fourth embodiment in the non-replenishment state.

FIG. 14 is a partial sectional view of the ink replenishment container and the ink tank of a fifth embodiment in the replenishment state.

FIG. 15 is a partial sectional view of the ink replenishment container of the fifth embodiment in the non-replenishment state.

### DESCRIPTION OF EMBODIMENTS

### A. First Embodiment

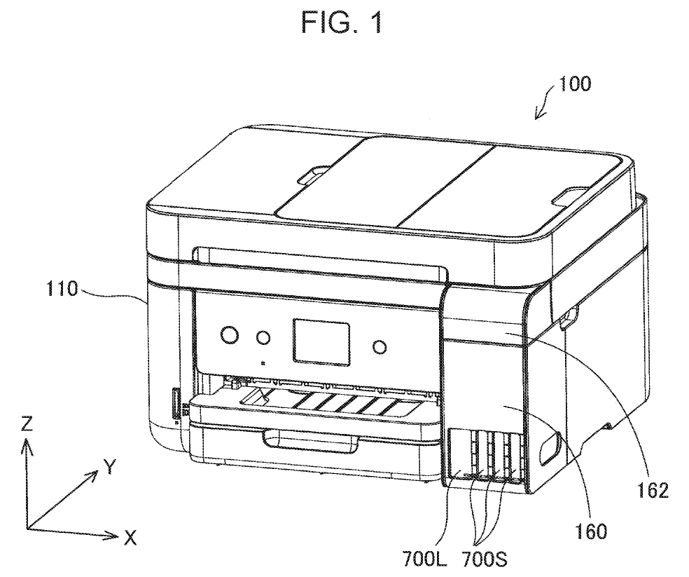

FIG. 1 is a perspective view of a printer 100. The printer 100 is an ink jet printer that ejects ink onto a print medium to perform printing. In FIG. 1, X-, Y-, and Z-axes orthogonal to each other are illustrated. The X-axis corresponds to a width direction of the printer 100, the Y-axis corresponds to a depth direction of the printer 100, and the Z-axis corresponds to a height direction of the printer 100. The printer 100 is installed on a horizontal installation surface defined by an X direction and a Y direction. Note that the "X direction" is a direction along the X-axis and means a concept including both a +X direction and a -X direction. Similarly, the "Y direction" is a direction along the Y-axis and means a concept including both a +Y direction and a -Y direction, and a "Z direction" is a direction along the Z-axis and means a concept including both a +Z direction which is a vertically upward direction and a -Z direction which is a vertically downward direction.

The printer 100 includes a housing 110. The housing 110 houses a carriage (not shown) movable in the X direction, which is a main scanning direction. The carriage is provided with a print head that ejects ink onto a print medium. An ink tank accommodating unit 160 that accommodates a plurality of ink tanks 700S and 700L is provided at one end of a front surface of the housing 110. The ink tank accommodating unit 160 includes an openable/closable lid 162 at an upper portion thereof. The ink tank 700S is a small-capacity tank, and the ink tank 700L is a large-capacity tank. Meanwhile, in the following description, both the ink tanks are also simply referred to as an "ink tank 700" without distinction. Each ink tank 700 is connected to the print head of the carriage by a tube (not shown). That is, the ink tanks 700 are stationary ink tanks that are not mounted on the carriage of the printer 100. Further, each ink tank 700 is an ink replenishment-type ink tank that is replenished with ink from an ink replenishment container when the remaining ink level is low. The ink tank 700 in the present disclosure is not limited to the stationary ink tank, and may be an ink tank mounted on the carriage of the printer 100.

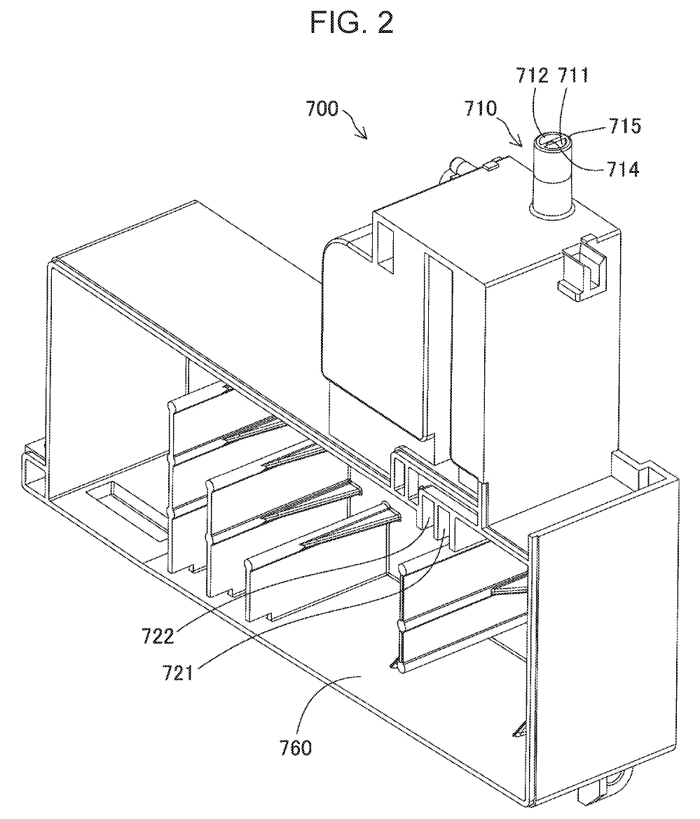

FIG. 2 is a perspective view of the ink tank 700. An ink introduction member 710 for replenishing ink to the ink tank 700 is provided on the upper surface of the ink tank 700. The ink introduction member 710 is a tubular member extending vertically upward from the ink tank 700, and communicates with the ink tank 700. The ink introduction member 710 has a plurality of introduction flow paths 711 and 712 partitioned by a partition 714. In the present embodiment, the ink introduction member 710 has two introduction flow paths 711 and 712. The two introduction flow paths 711 and 712 communicate with two in-tank flow paths 721 and 722, respectively, protruding into an ink accommodating chamber 760 of the ink tank 700. A part of a tip end surface 715 of the ink introduction member 710 corresponds to an end portion of the partition 714.

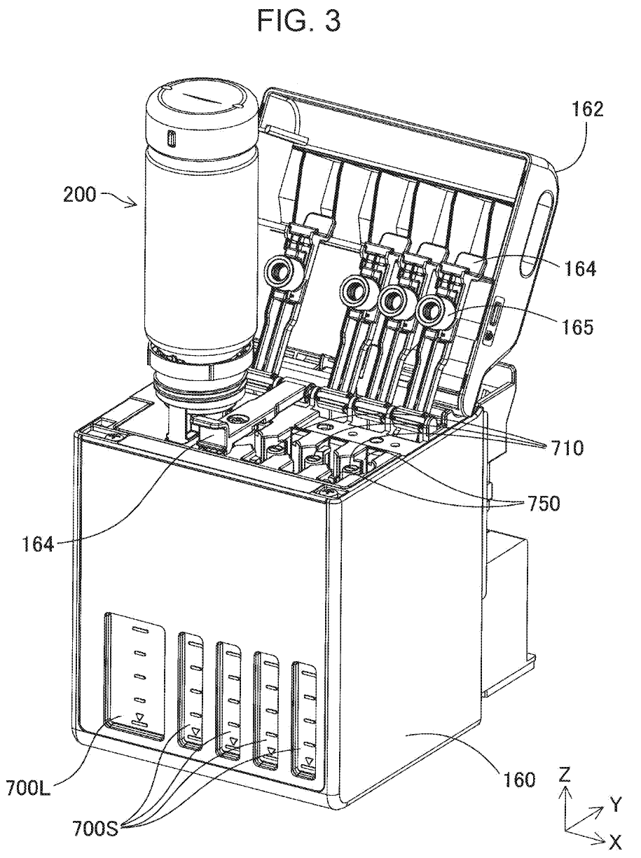

FIG. 3 is a perspective view showing a state where ink is replenished to the ink tank 700 by using an ink replenishment container 200. A front surface of each ink tank 700 is formed of a transparent member so that the remaining ink level of each ink tank 700 can be seen from the outside. When the remaining ink level is low, the user can open the lid 162 and ink is replenished to the ink tank 700 via the ink introduction member 710, as shown in FIG. 3.

The ink tank accommodating unit 160 includes a sealing cap member 164 having a sealing cap 165 for sealing a tip end of the ink introduction member 710. In a state where ink is not replenished to the ink tank 700, the tip end of the ink introduction member 710 is sealed by the sealing cap 165. When ink is replenished to the ink tank 700, the sealing cap member 164 is removed from the ink introduction member 710, and a leading end portion of the ink replenishment container 200 is inserted at the position of the ink introduction member 710. In the present specification, the term "ink replenishment" means an operation of supplying ink to the ink tank 700 to increase the remaining ink level. However, the ink tank 700 does not need to be completely filled with the ink through the "ink replenishment". In addition, the "ink replenishment" also means an operation of filling an empty ink tank 700 with the ink when the printer 100 is used for the first time.

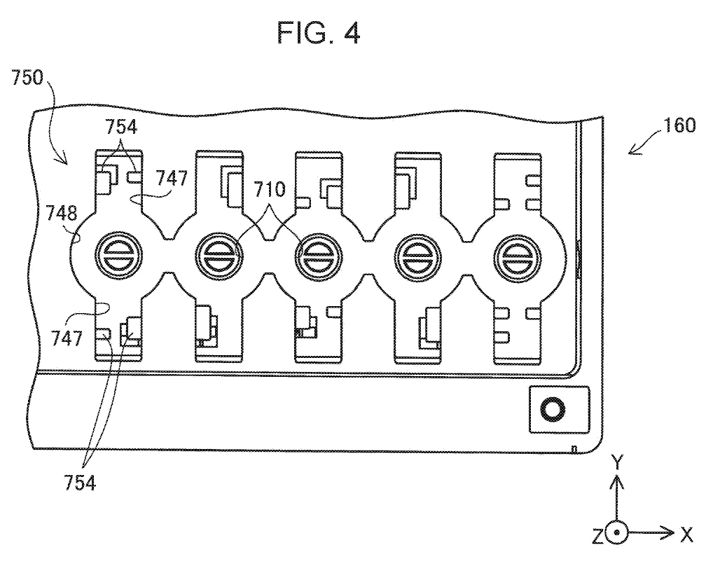

FIG. 4 is a top view of the ink tank accommodating unit 160 in a state where the sealing cap members 164 are removed. A slot portion 750 surrounding each of the ink introduction members 710 is formed on the upper surface of the ink tank accommodating unit 160. The slot portion 750 is a bottomed recessed portion or a through hole. The slot portion 750 has a first hole portion 748 and a pair of second hole portions 747, the first hole portion 748 and the second hole portions 747 being opened in the upper surface of the ink tank accommodating unit 160. The first hole portion 748 has a substantially circular outer shape. The ink introduction member 710 is disposed in the first hole portion 748. The pair of second hole portions 747 are disposed on both sides of the first hole portion 748 in the Y direction, which is the front-rear direction. Each of the pair of second hole portions 747 has a substantially rectangular outer shape.

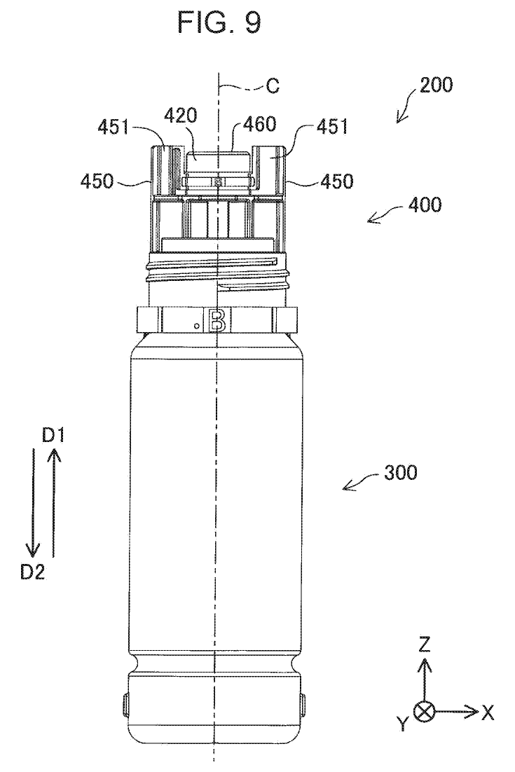

Each of the pair of second hole portions 747 has a tank identification member 754 for identifying the ink replenishment container 200 connectable to the corresponding ink introduction member 710. The tank identification member 754 is a recess-and-projection portion having a pattern defined by a plurality of ribs. When an incorrect ink replenishment container 200, such as one having a different ink color, is attempted to be inserted into the ink introduction member 710, the tank identification member 754 collides with a projection portion 451 (FIG. 9), which will be described later, of the ink replenishment container 200 during the insertion process. This allows the insertion process to be interrupted. On the other hand, when a correct ink replenishment container 200 is attempted to be inserted into the ink introduction member 710, the insertion process can be continued without collision between the tank identification member 754 and the projection portion 451 of the ink replenishment container 200.

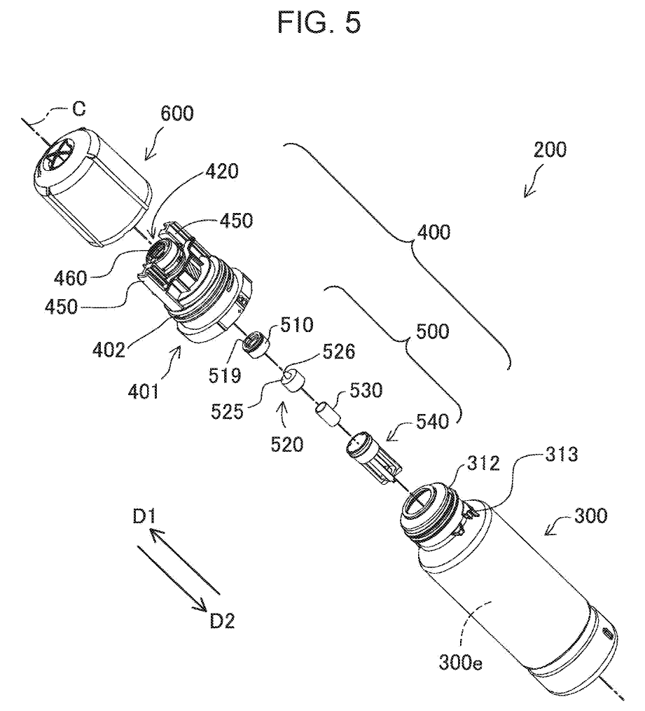

FIG. 5 is an exploded perspective view of the ink replenishment container 200. As shown in FIG. 5, the ink replenishment container 200 includes a container portion 300, a spout portion 400, and a cap 600 configured to be attachable to and detachable from the spout portion 400. The ink replenishment container 200 has a central axis C.

Hereinafter, the cap 600 side of the ink replenishment container 200 is referred to as an "upper end side" or a "leading end side", and the container portion 300 side is referred to as a "lower end side" or a "trailing end side". In addition, a direction along the central axis C of the ink replenishment container 200, that is, a direction parallel to the central axis C is referred to as an "axial direction", and a direction orthogonal to the axial direction is referred to as a "radial direction". A direction from the trailing end side toward the leading end side in the axial direction is referred to as a "first direction D1". A direction opposite to the first direction D1 is referred to as a "second direction D2".

The container portion 300 is a hollow cylindrical container having an opening on the leading end side, and has an ink accommodating portion 300e which is a space capable of accommodating ink therein. The small-diameter portion at the leading end of the container portion 300 is provided with an external thread 312 for attaching the spout portion 400. The container portion 300 has a metal portion that is a portion containing metal. In the present embodiment, the entire container portion 300 is formed of metal. Note that only a part of the container portion 300, such as an outer wall or an inner wall of the container portion 300 or a part of a layer forming the container portion 300, may be formed of metal. In this case, the portion of the container portion 300 other than the metal portion is formed of, for example, a thermoplastic resin such as polyethylene or polypropylene. The metal portion may also be attachable or stickable to the container portion 300. The metal portion preferably contains a metal having a high specific gravity. The metal contained in the metal portion is, for example, SUS or iron.

The spout portion 400 includes an ink outlet forming portion 401 and a spring valve unit 500.

The ink outlet forming portion 401 is connected to the leading end side of the container portion 300. The ink outlet forming portion 401 has the same central axis C as the ink replenishment container 200. On the inner side of the ink outlet forming portion 401, an internal thread (not shown) to be screwed with the external thread 312 of the container portion 300 is provided. On the outer side of the ink outlet forming portion 401, an external thread 402 for attaching the cap 600 is provided. Further, teeth (not shown) constituting one of two parts of a ratchet mechanism are provided on the inner circumference of the trailing end portion of the ink outlet forming portion 401. On the trailing end side of the external thread 312 of the container portion 300, a claw 313 which constitutes the other one of the two parts of the ratchet mechanism and engages with the teeth is provided. The ratchet mechanism has a function of restricting rotation in a direction opposite to the direction in which the internal thread of the ink outlet forming portion 401 and the external thread 312 of the container portion 300 are screwed together. This ratchet mechanism suppresses the ink outlet forming portion 401 from rotating together with the cap 600 and coming off from the container portion 300 when the user unscrews and removes the cap 600 from the external thread 402.

An ink outlet 460 through which ink is discharged is provided at the leading end of the ink outlet forming portion 401. In a state where the ink outlet forming portion 401 and the container portion 300 are connected to each other, the ink outlet 460 is in fluid communication with the ink accommodating portion 300e of the container portion 300. The ink outlet forming portion 401 is connected to the container portion 300 and includes a tubular portion 420 having the ink outlet 460. The spring valve unit 500 is attached in the tubular portion 420. When ink is replenished to the ink tank 700 of the printer 100, the ink introduction member 710 of the ink tank 700 is inserted into the ink outlet 460. The ink outlet 460 is formed in a cylindrical shape so that the ink introduction member 710 is inserted thereinto. In the present disclosure, the ink outlet 460 is also simply referred to as an outlet.

The ink outlet forming portion 401 has a metal portion that is a portion containing metal. In the present embodiment, the entire ink outlet forming portion 401 is formed of metal. Note that only a part of the ink outlet forming portion 401 may be formed of metal. In this case, the portion of the ink outlet forming portion 401 other than the metal portion is formed of, for example, a thermoplastic resin such as polyethylene or polypropylene. The metal portion preferably contains a metal having a high specific gravity. The metal contained in the metal portion is, for example, SUS or iron.

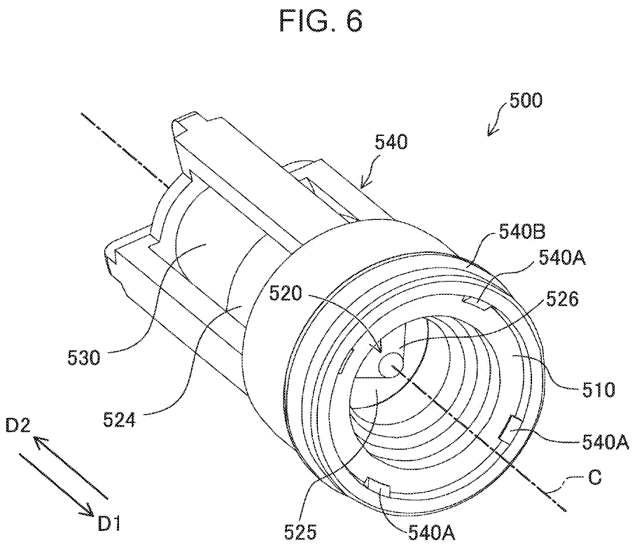

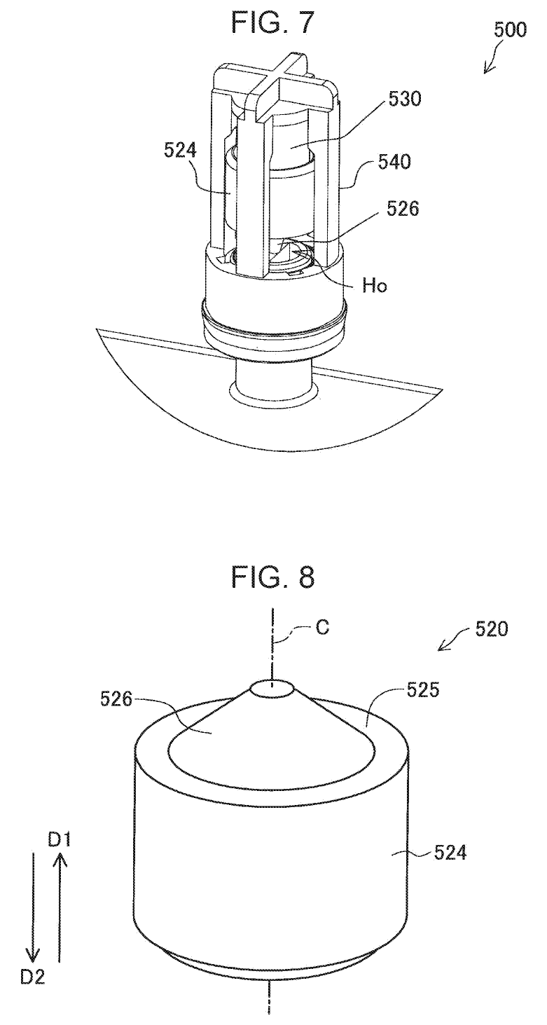

FIG. 6 is a first perspective view of the spring valve unit 500. FIG. 7 is a second perspective view of the spring valve unit 500. FIG. 7 shows a state where the ink introduction member 710 is inserted into the ink outlet 460. As shown in FIGS. 5-7, the spring valve unit 500 includes a holder member 540, a spring member 530, a valve body 520, and a seal member 510.

The holder member 540 accommodates the spring member 530, the valve body 520, and the seal member 510 therein. In other words, the holder member 540 holds the spring member 530, the valve body 520, and the seal member 510. The holder member 540 has a substantially cylindrical shape in which an end portion on the leading end side in the axial direction is opened and an end portion on the trailing end side in the axial direction is closed. In the holder member 540, the ink introduction member 710 can be inserted into and removed from an opening formed on the leading end side. The holder member 540 is attached in the tubular portion 420 so as to provide a gap in the radial direction between the holder member 540 and the tubular portion 420. As shown in FIG. 6, on the leading end side, the holder member 540 has retaining portions 540A for suppressing the seal member 510 from coming off from the holder member 540 and an engaging portion 540B for engaging with the tubular portion 420. Further, as shown in FIG. 7, the holder member 540 has a through hole Ho. The through hole Ho is a hole that extends through the side wall of the holder member 540 in the radial direction, and is formed so as to extend also in the axial direction. The through hole Ho communicates with a radial gap between the holder member 540 and the tubular portion 420.

The spring member 530 is accommodated in the holder member 540 and is supported by the holder member 540. The spring member 530 is accommodated on the trailing end side in the axial direction in the holder member 540. In the present embodiment, the spring member 530 is a coil spring. The spring member 530 biases the valve body 520 in the first direction D1. The spring member 530 has a spring force that is smaller than the self-weight of the ink replenishment container 200 including the container portion 300 in a state where the ink in the ink accommodating portion 300e is empty and the spout portion 400.

The valve body 520 is disposed in the holder member 540 so as to be movable in the axial direction. The valve body 520 is accommodated in the holder member 540 further on the leading end side in the axial direction than the spring member 530.

In the present embodiment, at least one of the holder member 540, the spring member 530, and the valve body 520 has a metal portion that is a portion containing metal. Of the three members described above, the member having the metal portion may be entirely formed of metal, or may be only partially formed of metal. When only a part is formed of metal, a portion other than the metal portion is formed of, for example, a thermoplastic resin such as polyethylene or polypropylene. The metal portion preferably contains a metal having a high specific gravity. The metal contained in the metal portion is, for example, SUS or iron.

FIG. 8 is a view showing a configuration of the valve body 520. The valve body 520 has a cylindrical portion 524, a seal surface 525, and a protrusion 526.

The cylindrical portion 524 has a cylindrical shape extending in the axial direction. The cylindrical portion 524 faces the inner surface of the holder member 540. The cylindrical portion 524 is slidable in the axial direction by being guided by the inner surface of the holder member 540.

The seal surface 525 is formed on an end surface located on the first direction D1 side of the cylindrical portion 524. The seal surface 525 extends in the radial direction of the cylindrical portion 524. The seal surface 525 has an annular shape when viewed along the axial direction.

The protrusion 526 is formed further inside in the radial direction of the cylindrical portion 524 than the seal surface 525. The protrusion 526 is located further on the ink outlet 460 side than the seal surface 525 in the axial direction. The shape of the protrusion 526 is a truncated conical shape in which the cross-sectional area in the radial direction is larger on the second direction D2 side than on the first direction D1 side.

The seal member 510 is attached inside the holder member 540. The seal member 510 is located between the valve body 520 and the ink outlet 460 in the axial direction and constitutes a valve seat. In other words, the seal member 510 is located further on the leading end side in the axial direction than the valve body 520 in the holder member 540. The seal member 510 is substantially ring-shaped. The seal member 510 is formed of, for example, an elastic rubber member or an elastomer. The seal member 510 has a through hole 519 that extends through the seal member 510 in the axial direction and into and from which the ink introduction member 710 is inserted and removed. The through hole 519 is formed by an inner circumferential surface of the seal member 510. The central axis of the through hole 519 coincides with the central axis C of the ink replenishment container 200.

FIG. 9 is a side view of the ink replenishment container 200 in an upright state with the spout portion 400 being connected to the container portion 300. The ink replenishment container 200 shown in FIG. 9 is in a state where the cap 600 is removed. The "upright state of the ink replenishment container 200" is a state where the ink outlet 460 faces upward and the ink replenishment container 200 is placed on a horizontal surface such as a desk with the bottom portion of the container portion 300 facing downward. The state where the ink outlet 460 faces upward is a state where a direction in which the ink outlet 460 opens is the vertically upward direction. As shown in FIG. 3 described above, replenishment of ink into the ink tank 700 is performed in an inverted state where the leading end side of the ink replenishment container 200 faces downward.

As shown in FIGS. 5 and 9, the spout portion 400 further includes an attachment 450. The attachment 450 is disposed on the outer side relative to the tubular portion 420 in the radial direction. In other words, the distance between the attachment 450 and the central axis C of the ink replenishment container 200 is larger than the distance between the tubular portion 420 and the central axis C. The attachment 450 has two projection portions 451 in a 180-degree rotationally-symmetrical shape about the central axis C. The attachment 450 is provided so as to be attachable to the spout portion 400. The attachment 450 is attached to the spout portion 400 by, for example, press-fitting or fitting. The attachment 450 is integrated with the spout portion 400 by being attached to the spout portion 400. Note that the attachment 450 may be fixed to or formed integrally with the spout portion 400. The attachment 450 has a metal portion that is a portion containing metal. In the present embodiment, the entire attachment 450 is formed of metal. Note that only a part of the attachment 450 may be formed of metal. In this case, the portion of the attachment 450 other than the metal portion is formed of, for example, a thermoplastic resin such as polyethylene or polypropylene. The metal portion preferably contains a metal having a high specific gravity. The metal contained in the metal portion is, for example, SUS or iron.

The attachment 450 is provided with the two projection portions 451 that protrude in the first direction D1. The shape of the projection portion 451 varies depending on the type of ink accommodated in the ink replenishment container 200. That is, the projection portion 451 has an identification shape for identifying the type of ink accommodated in the ink accommodating portion 300e of the container portion 300. The projection portion 451 is provided so as to be insertable into the slot portion 750 provided around the ink introduction member 710 of the ink tank 700. The attachment 450 is a positioning member for positioning the ink replenishment container 200 by being fitted into the slot portion 750. The positioning is, for example, at least one of a function of suppressing erroneous ink pouring by fitting the ink replenishment container 200 for replenishing yellow ink to the slot portion 750 corresponding to the ink tank 700 accommodating yellow ink and preventing the ink replenishment container 200 for replenishing other color inks such as magenta ink and cyan ink from being fitted, and a function of stabilizing the ink pouring orientation of the ink replenishment container 200. The function of suppressing erroneous ink pouring is to prevent not only erroneous pouring of a different color ink but also, for example, in the case of black ink, erroneous pouring between dye-based black ink and pigment-based black ink. At the time of ink replenishment, the respective projection portions 451 of the attachment 450 are fitted into the slot portions 750, whereby the orientation of the ink replenishment container 200 is limited to two orientations that are 180-degree rotationally symmetrical. Thus, the ink replenishment container 200 can remain in a stable orientation during ink replenishment. Noted that "fitting" includes loosely fitting via a slight gap.

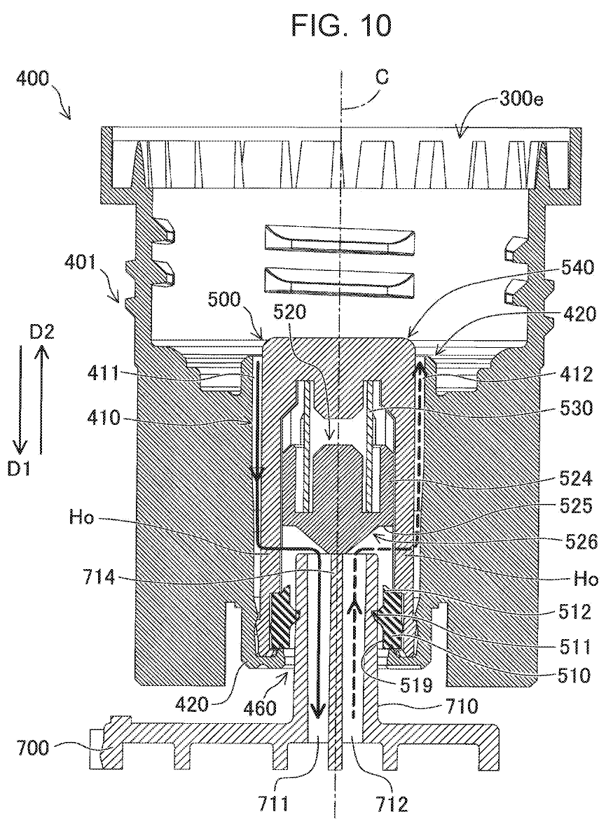

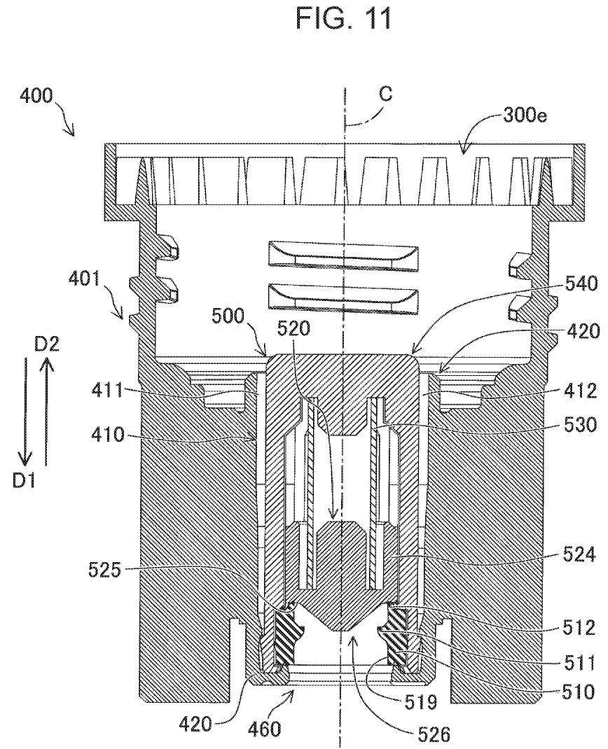

FIG. 10 is a partial sectional view of the ink replenishment container 200 and the ink tank 700 in a replenishment state where ink is replenished to the ink tank 700. FIG. 10 shows a cross section of a part of the configuration of the ink replenishment container 200 and a part of the configuration of the ink introduction member 710 when cut along the central axis C. In the replenishment state, the ink replenishment container 200 is in an inverted orientation. In the replenishment state, the spring valve unit 500 is in a valve-open state where the sealing of the ink outlet 460 is released so that the ink flows into the ink introduction member 710. In the valve-open state of the spring valve unit 500, the valve body 520 is pushed toward the second direction D2 by the ink introduction member 710 inserted into the ink outlet forming portion 401 to be separated from the seal member 510. In the valve-open state, the partition 714 of the ink introduction member 710 comes into contact with the tip end of the protrusion 526 of the valve body 520.

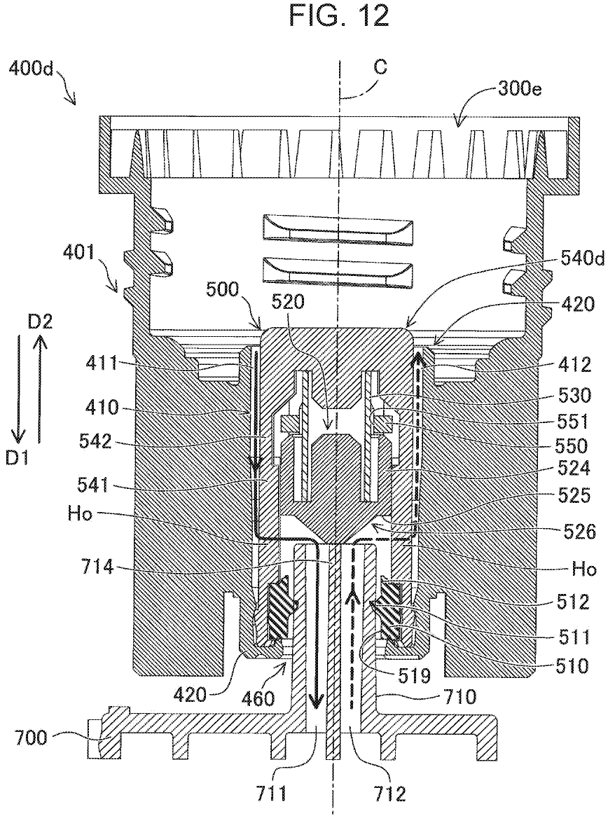

FIG. 11 is a partial sectional view of the ink replenishment container 200 in a non-replenishment state where ink is not replenished to the ink tank 700. FIG. 11 shows a cross section of a part of the configuration of the ink replenishment container 200 cut along the central axis C. In the non-replenishment state, the spring valve unit 500 is in a valve-closed state where the ink outlet 460 is sealed so that the ink in the ink accommodating portion 300e does not leak to the outside. In the valve-closed state of the spring valve unit 500, the ink introduction member 710 is removed from the inside of the ink outlet forming portion 401, and thus the spring member 530 biases the valve body 520 toward the seal member 510 to bring the valve body 520 into contact with the seal member 510.

As shown in FIGS. 10 and 11, the ink outlet forming portion 401 further has an ink flow path 410. The ink flow path 410 is configured as a flow path space inside the tubular portion 420. The ink flow path 410 communicates with the ink accommodating portion 300e of the container portion 300 and the ink outlet 460 of the ink outlet forming portion 401. The spring valve unit 500 is located in the ink flow path 410. As shown in FIG. 10, the ink introduction member 710 is inserted into the ink flow path 410 through the through hole 519 of the seal member 510. The ink flow path 410 has a plurality of replenishment flow paths. In the present embodiment, the ink flow path 410 has two replenishment flow paths 411 and 412. Each of the two replenishment flow paths 411 and 412 is formed by a gap between the inner circumferential surface of the tubular portion 420 and the outer circumferential surface of the spring valve unit 500. In the valve-open state, the protrusion 526 of the valve body 520 is pushed by the ink introduction member 710, and the valve body 520 moves in the second direction D2, whereby the introduction flow paths 711 and 712 of the ink introduction member 710 communicate with the replenishment flow paths 411 and 412, respectively, via the through hole Ho. One of the two replenishment flow paths 411 and 412 is used as an ink flow path, and the other is used as an air flow path. In FIG. 10, the solid line arrows indicate a flow of the ink, and the broken line arrows indicate a flow of air. In the present embodiment, a first replenishment flow path 411 is used as the ink flow path. A second replenishment flow path 412 is used as the air flow path.

The seal member 510 includes a first seal portion 511 and a second seal portion 512.

The first seal portion 511 is formed on the inner circumferential surface of the seal member 510. The first seal portion 511 is provided along the circumferential direction of the inner circumferential surface of the seal member 510 forming the through hole 519, and protrudes toward the central axis C. The first seal portion 511 comes into contact with a side surface of the ink introduction member 710 inserted into the through hole 519 in the valve-open state to seal the through hole. Since the first seal portion 511 is in contact with the side surface of the ink introduction member 710, in the valve-open state, leakage of ink from the ink replenishment container 200 to the outside of the ink introduction member 710 is suppressed.

The second seal portion 512 is formed at an end portion of the seal member 510 on the second direction D2 side. The second seal portion 512 protrudes toward the seal surface 525 of the valve body 520 along the central axis C. The second seal portion 512 switches communication between the replenishment flow paths 411 and 412 and the introduction flow paths 711 and 712. As shown in FIG. 11, the second seal portion 512 is biased by the spring member 530 to come into contact with the seal surface 525 of the valve body 520 in the valve-closed state of the spring valve unit 500, thereby closing the through hole 519. As a result, the second seal portion 512 blocks the communication between the replenishment flow paths 411 and 412 and the introduction flow paths 711 and 712. On the other hand, as shown in FIG. 10, when the ink introduction member 710 is inserted into the tubular portion 420 from the ink outlet 460 and the valve body 520 is pressed in the second direction D2, the second seal portion 512 is separated from the seal surface 525 of the valve body 520. As a result, in the valve-open state of the spring valve unit 500, a gap is formed between the second seal portion 512 and the valve body 520. In other words, in the valve-open state of the spring valve unit 500, the ink introduction member 710 is inserted through the through hole 519 and presses the valve body 520 in the second direction D2, thereby forming a gap through which the ink and air flow is formed between the seal member 510 and the valve body 520. In addition, in the valve-closed state of the spring valve unit 500, the ink introduction member 710 is removed through the through hole 519, and thus the valve body 520 comes into contact with the seal member 510 and the through hole 519 is closed.

According to the first embodiment described above, the container portion 300 and the spout portion 400 have a metal portion containing metal, and the spring member 530 has a spring force that is smaller than the self-weight of the ink replenishment container 200 including the container portion 300 in a state where the ink in the ink accommodating portion 300e is empty and the spout portion 400. Therefore, it is possible to reduce the possibility that the ink replenishment container 200 moves in a direction away from the ink introduction member 710 of the printer 100 in the replenishment orientation in which ink is replenished to the ink tank 700. Specifically, it is possible to reduce the possibility that the ink replenishment container 200 moves upward with respect to the ink introduction member 710 in the replenishment orientation. Therefore, the ink replenishment orientation of the ink replenishment container 200 can be stabilized. Therefore, it is possible to reduce the possibility of occurrence of problems such as leakage of ink to a portion other than the ink introduction member 710, a decrease in ink replenishment amount, and an increase in ink replenishment time.

In the present embodiment, at least one of the spring member 530, the valve body 520, and the holder member 540 has a metal portion. Therefore, the degree of freedom of the arrangement of the metal portion is improved, and the adjustment of the self-weight of the ink replenishment container 200 becomes easy. In addition, since it is not necessary to provide the metal portion separately from the spring valve unit 500, it is possible to suppress the structure of the ink replenishment container 200 from becoming complicated.

### B. Second Embodiment

The second embodiment is different from the first embodiment in that the spout portion 400 does not have a metal portion. The configuration of each portion of the ink replenishment container 200 other than the spout portion 400 in the second embodiment is the same as that of the first embodiment. In the second embodiment, the spout portion 400 is made of a material other than metal. Specifically, the ink outlet forming portion 401, the attachment 450, the spring member 530, the valve body 520, and the holder member 540 are made of, for example, a thermoplastic resin such as polyethylene or polypropylene.

According to the second embodiment described above, the container portion 300 has a metal portion, and the spout portion 400 does not have a metal portion. The container portion 300 has a surface area and a volume larger than those of the spout portion 400, and has a simple shape. Therefore, it is possible to improve the degree of freedom of the arrangement of the metal portion in the ink replenishment container 200. In addition, it is possible to easily increase the self-weight of the ink replenishment container 200.

### C. Third Embodiment

The third embodiment is different from the first embodiment in that the container portion 300 does not have a metal portion. The configuration of each portion of the ink replenishment container 200 other than the container portion 300 in the third embodiment is the same as that of the first embodiment. In the third embodiment, the container portion 300 is made of a material other than metal. The container portion 300 is made of, for example, a thermoplastic resin such as polyethylene or polypropylene.

According to the third embodiment described above, the spout portion 400 has a metal portion, and the container portion 300 does not have a metal portion. Therefore, the center of gravity of the ink replenishment container 200 in the inverted state is located further downward, and the ink replenishment orientation is easily stabilized. Therefore, it is possible to reduce the possibility of occurrence of problems such as leakage of ink to a portion other than the ink introduction member 710, a decrease in ink replenishment amount, and an increase in ink replenishment time.

Further, in the present embodiment, similarly to the first embodiment, the ink replenishment container 200 is provided with the attachment 450 that is integrated with the spout portion 400 by being attached to the spout portion 400, and the attachment 450 has a metal portion. Therefore, even in a case where the spout portion 400 is constituted by a member having a specific gravity smaller than that of metal, the self-weight of the ink replenishment container 200 can be easily increased, and the center of gravity of the ink replenishment container 200 in the inverted state can be easily located downward. Therefore, it is possible to reduce the possibility of occurrence of problems such as leakage of ink to a portion other than the ink introduction member 710, a decrease in ink replenishment amount, and an increase in ink replenishment time.

In addition, in the present embodiment, similarly to the first embodiment, the attachment 450 is provided with the projection portions 451 that are insertable into the slot portion 750 disposed around the ink introduction member 710. Therefore, the center of gravity of the ink replenishment container 200 in the inverted state can be easily located downward. In addition, the projection portions 451 are inserted into the slot portions 750, respectively, and thus it is possible to make the ink replenishment container 200 less likely to fall in the replenishment orientation in which ink is replenished to the ink tank 700.

Further, in the present embodiment, the shape of the projection portion 451 varies depending on the type of ink accommodated in the ink replenishment container 200. For this reason, it is possible to provide the ink replenishment container 200 with a function of suppressing the erroneous pouring of the ink into the ink tank 700.

In the present embodiment, at least one of the spring member 530, the valve body 520, and the holder member 540 has a metal portion. Therefore, the degree of freedom in selecting which of the spring member 530, the valve body 520, and the holder member 540 is to be used as a member having a metal portion is improved, and the self-weight of the ink replenishment container 200 can be easily adjusted. In addition, since it is not necessary to provide the metal portion separately from the spring valve unit 500, it is possible to suppress the structure of the ink replenishment container 200 from becoming complicated.

### D. Fourth Embodiment

The fourth embodiment is different from the first embodiment in the configuration of a spout portion 400d. The configuration of each portion of the ink replenishment container 200 other than the spout portion 400d in the fourth embodiment is the same as that of the first embodiment.

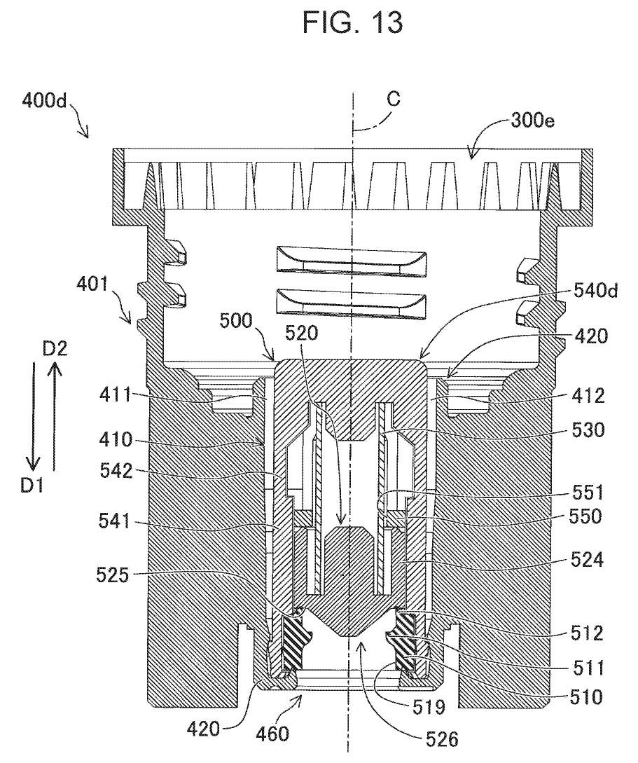

FIG. 12 is a partial sectional view of the ink replenishment container 200 and the ink tank 700 of the fourth embodiment in the replenishment state. FIG. 13 is a partial sectional view of the ink replenishment container 200 of the fourth embodiment in the non-replenishment state. In the fourth embodiment, the spout portion 400d further has a stopper member 550. The stopper member 550 is attached in a holder member 540d. The stopper member 550 is located between the valve body 520 and the ink accommodating portion 300e of the container portion 300 in the axial direction. In other words, the stopper member 550 is located further on the trailing end side in the axial direction than the valve body 520. The stopper member 550 is substantially ring-shaped. The stopper member 550 has a through hole 551 passing through the stopper member 550 in the axial direction. A part of the spring member 530 is disposed in

the through hole 551. The central axis C of the through hole 551 coincides with the central axis C of the ink replenishment container 200. The stopper member 550 has a metal portion that is a portion containing metal. In the present embodiment, the entire stopper member 550 is formed of metal. Note that only a part of the stopper member 550 may be formed of metal. In this case, the portion of the stopper member 550 other than the metal portion is formed of, for example, a thermoplastic resin such as polyethylene or polypropylene. The metal portion preferably contains a metal having a high specific gravity. The metal contained in the metal portion is, for example, SUS or iron.

In the fourth embodiment, the holder member 540d includes a first width portion 541 and a second width portion 542 in which the width of an internal space of the holder member 540 is wider than in the first width portion 541. The internal space of the holder member 540d is a space in which the spring member 530, the valve body 520, and the seal member 510 are accommodated. The width of the internal space means the length of the internal space in the radial direction. The width of the internal space of the holder member 540d in the first width portion 541 is equal to or narrower than the diameter of the stopper member 550. The width of the internal space of the holder member 540d in the second width portion 542 is equal to or wider than the diameter of the stopper member 550. The first width portion 541 is provided further on the leading end side than the second width portion 542. In other words, the distance between the first width portion 541 and the ink outlet 460 in the axial direction is shorter than the distance between the second width portion 542 and the ink outlet 460 in the axial direction.

As shown in FIG. 13, the stopper member 550 is locked inside the holder member 540d in the valve-closed state. Specifically, the stopper member 550 is press-fitted into the first width portion 541, and the outer circumferential surface of the stopper member 550 and the inner circumferential surface of the first width portion 541 are brought into contact with each other, whereby the stopper member 550 is locked inside the holder member 540d. When the stopper member 550 is locked inside the holder member 540d, the flow of the ink in the ink flow path 410 is restricted. As shown in FIG. 12, when the ink introduction member 710 is inserted into the ink flow path 410, the stopper member 550 is pushed by the ink introduction member 710 via the valve body 520 and moves from the first width portion 541 to the second width portion 542. As a result, the stopper member 550 is released from locking, and the ink can flow in the ink flow path 410. Even after the ink introduction member 710 is removed from the ink flow path 410 and the spring valve unit 500 transitions from the valve-open state to the valve-closed state, the stopper member 550 remains in the second width portion 542. That is, in the ink replenishment container 200 before the start of use, the stopper member 550 is locked inside the holder member 540d.

According to the fourth embodiment described above, the spout portion 400d includes the stopper member 550. The stopper member 550 is locked inside the holder member 540d between the valve body 520 and the ink accommodating portion 300e of the container portion 300 in the direction along the central axis C of the spout portion 400d to restrict the flow of the ink in the ink flow path 410, and the stopper member 550 is released from locking by being pressed by the ink introduction member 710 via the valve body 520 to allow the ink to flow in the ink flow path 410. The stopper member 550 has a metal portion. Therefore, the self-weight of the ink replenishment container 200 can be adjusted more easily. In addition, it is possible to suppress the movement of the valve body 520 in the second direction D2 due to the impact on the ink replenishment container 200 during transportation or the like before the start of use of the ink replenishment container 200, and to suppress the leakage of the ink.

### E. Fifth Embodiment

The fifth embodiment is different from the first embodiment in the configuration of a spout portion 400e. The configuration of each portion of the ink replenishment container 200 other than the spout portion 400e in the fifth embodiment is the same as that of the first embodiment.

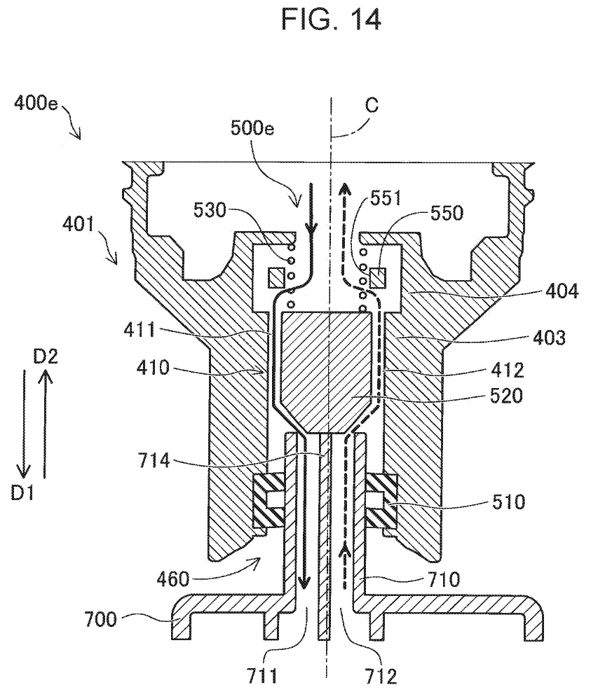

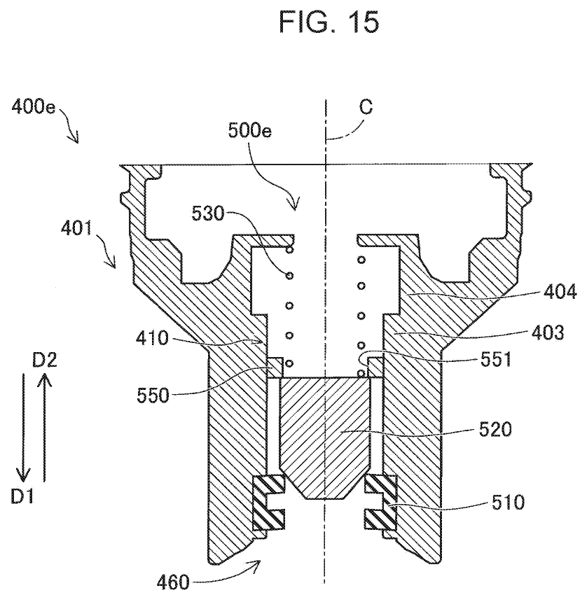

FIG. 14 is a partial sectional view of the ink replenishment container 200 and the ink tank 700 of the fifth embodiment in the replenishment state. FIG. 15 is a partial sectional view of the ink replenishment container 200 of the fifth embodiment in the non-replenishment state. In the fifth embodiment, the spring valve unit 500e does not have the holder member 540. The seal member 510 is fixed to an inner wall forming the ink flow path 410 of the ink outlet forming portion 401. The spring member 530 is disposed in the ink flow path 410 and is supported by the ink outlet forming portion 401 and the valve body 520.

In the fifth embodiment, the spout portion 400e further has the stopper member 550. The stopper member 550 is disposed in the ink flow path 410. The stopper member 550 is located between the valve body 520 and the ink accommodating portion 300e of the container portion 300 in the axial direction. In other words, the stopper member 550 is located further on the trailing end side in the axial direction than the valve body 520. The stopper member 550 is substantially ring-shaped. The stopper member 550 has the through hole 551 passing through the stopper member 550 in the axial direction. A part of the spring member 530 is disposed in the through hole 551. The central axis C of the through hole 551 coincides with the central axis C of the ink replenishment container 200. The stopper member 550 has a metal portion that is a portion containing metal. In the present embodiment, the entire stopper member 550 is formed of metal. Note that only a part of the stopper member 550 may be formed of metal. In this case, the portion of the stopper member 550 other than the metal portion is formed of, for example, a thermoplastic resin such as polyethylene or polypropylene. The metal portion preferably contains a metal having a high specific gravity. The metal contained in the metal portion is, for example, SUS or iron.

In the fifth embodiment, the ink outlet forming portion 401 includes a third width portion 403 and a fourth width portion 404 in which the width of the ink flow path 410 is wider than in the third width portion 403. The width of the ink flow path 410 means the length of the ink flow path 410 in the radial direction. The width of the ink flow path 410 in the third width portion 403 is equal to or narrower than the diameter of the stopper member 550. The width of the ink flow path 410 in the fourth width portion 404 is wider than the diameter of the stopper member 550. The third width portion 403 is provided further on the leading end side than the fourth width portion 404. In other words, the distance between the third width portion 403 and the ink outlet 460 in the axial direction is shorter than the distance between the fourth width portion 404 and the ink outlet 460 in the axial direction.

As shown in FIG. 15, the stopper member 550 is locked inside the ink flow path 410 in the valve-closed state. Specifically, the stopper member 550 is press-fitted into the third width portion 403, and the outer circumferential surface of the stopper member 550 and the inner circumferential surface of the third width portion 403 are brought into contact with each other, whereby the stopper member 550 is locked inside the ink flow path 410. When the stopper member 550 is locked inside the ink flow path 410, the flow of the ink in the ink flow path 410 is restricted. As shown in FIG. 14, when the ink introduction member 710 is inserted into the ink flow path 410, the stopper member 550 is pushed by the ink introduction member 710 via the valve body 520 and moves from the third width portion 403 to the fourth width portion 404. As a result, the stopper member 550 is released from locking, and the ink can flow in the ink flow path 410. Even after the ink introduction member 710 is removed from the ink flow path 410 and the spring valve unit 500e transitions from the valve-open state to the valve-closed state, the stopper member 550 remains in the fourth width portion 404.

According to the fifth embodiment described above, the spout portion 400e includes the stopper member 550 that is locked inside the ink flow path 410 to restrict the flow of the ink. The stopper member 550 is located between the valve body 520 and the ink accommodating portion 300e of the container portion 300 in the direction along the central axis C of the spout portion 400e, and the stopper member 550 is released from locking by being pressed by the ink introduction member 710 via the valve body 520 to allow the ink to flow in the ink flow path 410. The stopper member 550 has a metal portion. Therefore, the self-weight of the ink replenishment container 200 can be further increased. In addition, it is possible to suppress the movement of the valve body 520 in the second direction D2 due to the impact on the ink replenishment container 200 during transportation or the like before the start of use of the ink replenishment container 200, and to suppress the leakage of the ink.

### F. Other Embodiments

(F-1) In the above embodiments, the spout portion 400 includes the attachment 450. However, the spout portion 400 need not include the attachment 450.

(F-2) In the above embodiments, the attachments 450 includes the projection portions 451. However, the attachment 450 need not include the projection portions 451.

(F-3) In the first embodiment, the third embodiment, the fourth embodiment, and the fifth embodiment, the attachment 450 has a metal portion. However, in the above embodiments, the attachment 450 need not have the metal portion.

(F-4) In the first embodiment, the third embodiment, the fourth embodiment, and the fifth embodiment, at least one of the holder member 540, the spring member 530, and the valve body 520 has a metal portion. However, in the above embodiments, none of the holder member 540, the spring member 530, and the valve body 520 needs to have a metal portion.

(F-5) In the first embodiment, the third embodiment, the fourth embodiment, and the fifth embodiment, the ink outlet forming portion 401 has a metal portion. However, in the above embodiments, the ink outlet forming portion 401 need not have a metal portion.

(F-6) In the fourth embodiment and the fifth embodiment, as in the first embodiment, the container portion 300 has a metal portion. However, in the above embodiments, the container portion 300 need not include the metal portion.

### G. Other Aspects

The present disclosure is not limited to the embodiments described above and can be implemented in various aspects without departing from the gist of the present disclosure. For example, the present disclosure can also be implemented in the following aspects. Technical features in the above embodiments corresponding to technical features in respective aspects described below can be appropriately replaced or combined in order to solve some or all of the problems of the present disclosure, or achieve some or all of the effects of the present disclosure. In addition, unless the technical features are described as essential in the present specification, the technical features can be deleted as appropriate.

(1) According to a first aspect of the present disclosure, there is provided an ink replenishment container from which ink is replenished to a printer, in which an ink introduction member communicating with an ink tank extends vertically upward, via the ink introduction member. The ink replenishment container includes: a container portion having an ink accommodating portion configured to accommodate the ink; and a spout portion connected to the container portion and having an outlet through which the ink is discharged, wherein the spout portion includes a spring valve unit, the spring valve unit including a valve body, a seal member located between the valve body and the outlet and constituting a valve seat, and a spring member that biases the valve body toward the seal member to bring the valve body into contact with the seal member in a valve-closed state of the spring valve unit, at least one of the container portion and the spout portion has a metal portion containing metal, and the spring member has a spring force that is smaller than a self-weight of the ink replenishment container including the container portion in a state where the ink is empty and the spout portion.

According to such an aspect, in the replenishment orientation in which ink is replenished to the ink tank, it is possible to reduce a possibility that the ink replenishment container moves in a direction away from the ink introduction member. Therefore, it is possible to stabilize the ink replenishment orientation of the ink replenishment container, and it is possible to reduce the possibility of the occurrence of problems such as leakage of ink to a portion other than the ink introduction member, a decrease in ink replenishment amount, and an increase in ink replenishment time.

(2) In the above aspect, the container portion may have the metal portion, and the spout portion need not have the metal portion.

According to such an aspect, it is possible to improve the degree of freedom of the arrangement of the metal portion in the ink replenishment container. In addition, it is possible to easily increase the self-weight of the ink replenishment container.

(3) In the above aspect, the spout portion may have the metal portion, and the container portion need not have the metal portion.

According to such an aspect, the center of gravity of the ink replenishment container in the inverted state is located further downward, and the ink replenishment orientation is easily stabilized. Therefore, it is possible to reduce the possibility of occurrence of problems such as leakage of ink to a portion other than the ink introduction member, a decrease in ink replenishment amount, and an increase in ink replenishment time.

(4) In the above aspect, the ink replenishment container may further include an attachment that is attached to the spout portion to be integrated with the spout portion, wherein the attachment may have the metal portion.

According to such an aspect, even in a case where the spout portion is constituted by a member having a smaller specific gravity than that of metal, it is possible to easily increase the self-weight of the ink replenishment container. In addition, the center of gravity of the ink replenishment container in the inverted state can be easily located downward.

(5) In the above aspect, the attachment may include a projection portion that is insertable into a slot portion disposed around the ink introduction member.

According to such an aspect, the center of gravity of the ink replenishment container in the inverted state can be easily located downward. In addition, the projection portion is inserted into the slot portion, and thus it is possible to make the ink replenishment container less likely to fall in the replenishment orientation in which ink is replenished to the ink tank.

(6) In the above aspect, the spout portion may include an ink flow path that allows the ink accommodating portion of the container portion to communicate with the outlet, and a stopper member that is locked inside the ink flow path to restrict a flow of the ink, the stopper member being located between the valve body and the ink accommodating portion in a direction along a central axis of the spout portion, being released from locking by being pressed by the ink introduction member via the valve body to allow the ink to flow in the ink flow path, and the stopper member may have the metal portion.

According to such an aspect, the self-weight of the ink replenishment container can be further increased. In addition, it is possible to suppress the movement of the valve body in a valve-opening direction of the spring valve unit due to the impact on the ink replenishment container during transportation or the like before the start of use of the ink replenishment container, and to suppress the leakage of the ink.

(7) In the above aspect, the spring valve unit may further include a holder member that holds at least the spring member and the valve body among the spring member, the valve body, and the seal member, and at least one of the spring member, the valve body, and the holder member may have the metal portion.

According to such an aspect, the degree of freedom in selecting which of the spring member, the valve body, and the holder member is to be used as a member having a metal portion is improved, and the self-weight of the ink replenishment container can be easily adjusted. In addition, since it is not necessary to provide the metal portion separately from the spring valve unit, it is possible to suppress the structure of the ink replenishment container from becoming complicated.

(8) In the above aspect, the spout portion may include an ink flow path that allows the ink accommodating portion of the container portion to communicate with the outlet, and a stopper member, the holder member may be located in the ink flow path, the stopper member may be locked inside the holder member between the valve body and the ink accommodating portion in a direction along a central axis of the spout portion to restrict a flow of the ink in the ink flow path, and the stopper member may be released from locking by being pressed by the ink introduction member via the valve body to allow the ink to flow in the ink flow path, and the stopper member may have the metal portion.

According to such an aspect, the self-weight of the ink replenishment container can be adjusted more easily. In addition, it is possible to suppress the movement of the valve body in a valve-opening direction of the spring valve unit due to the impact on the ink replenishment container during transportation or the like before the start of use of the ink replenishment container, and to suppress the leakage of the ink.

What is claimed is:

1. An ink replenishment container from which ink is replenished to a printer, in which an ink introduction member communicating with an ink tank extends vertically upward, via the ink introduction member, the ink replenishment container comprising:
a container portion having an ink accommodating portion configured to accommodate the ink; and
a spout portion connected to the container portion and having an outlet through which the ink is discharged,
wherein the spout portion includes a spring valve unit,
the spring valve unit including
a valve body,
a seal member located between the valve body and the outlet and constituting a valve seat, and
a spring member that biases the valve body toward the seal member to bring the valve body into contact with the seal member in a valve-closed state of the spring valve unit,
at least one of the container portion and the spout portion has a metal portion containing metal, and
the spring member has a spring force that is smaller than a self-weight of the ink replenishment container including the container portion in a state where the ink is empty and the spout portion.

2. The ink replenishment container according to claim 1, wherein
the container portion has the metal portion and the spout portion does not have the metal portion.

3. The ink replenishment container according to claim 1, wherein
the spout portion has the metal portion and the container portion does not have the metal portion.

4. The ink replenishment container according to claim 3, further comprising
an attachment that is attached to the spout portion to be integrated with the spout portion,
wherein the attachment has the metal portion.

5. The ink replenishment container according to claim 4, wherein
the attachment includes a projection portion that is insertable into a slot portion disposed around the ink introduction member.

6. The ink replenishment container according to claim 3, wherein
the spout portion includes
an ink flow path that allows the ink accommodating portion of the container portion to communicate with the outlet, and
a stopper member that is locked inside the ink flow path to restrict a flow of the ink, the stopper member being located between the valve body and the ink accommodating portion in a direction along a central axis of the spout portion, being released from locking by being pressed by the ink introduction member via the valve body to allow the ink to flow in the ink flow path, and
the stopper member has the metal portion.

7. The ink replenishment container according to claim 1, wherein
the spring valve unit further includes a holder member that holds at least the spring member and the valve body among the spring member, the valve body, and the seal member, and
at least one of the spring member, the valve body, and the holder member has the metal portion.

8. The ink replenishment container according to claim 7, wherein
the spout portion includes
an ink flow path that allows the ink accommodating portion of the container portion to communicate with the outlet, and
a stopper member,
the holder member is located in the ink flow path,
the stopper member is locked inside the holder member between the valve body and the ink accommodating portion in a direction along a central axis of the spout portion to restrict a flow of the ink in the ink flow path, and the stopper member is released from locking by being pressed by the ink introduction member via the valve body to allow the ink to flow in the ink flow path, and
the stopper member has the metal portion.
